(19) United States
(12) Patent Application Publication
(10) Pub. No.: US 2007/0063864 A1
(43) Pub. Date: Mar. 22, 2007

(54) Method for converting an appliance for use with a wireless communication device

(75) Inventors: William Flynn, Naugatuck, CT (US); Julie Brewster, Watertown, CT (US)

Correspondence Address: EDWARDS & ANGELL, LLP, P.O. BOX 55874, BOSTON, MA, 02205, US

(73) Assignee: Technology Licensing Corporation, Fort Lauderdale, FL (US)

(21) Appl. No.: 11/524,562

(22) Filed: Sep. 21, 2006

Related U.S. Application Data
(60) Provisional application No. 60/719,089, filed on Sep. 21, 2005.

(51) Int. Cl. G08C 19/00

(52) U.S. Cl. 340/825.69; 361/814; 343/702; 340/825.72

(57) ABSTRACT

An appliance has a metallic housing. A radio frequency transceiver is mounted on the surface of the housing. The radio frequency transceiver is operatively coupled to an appliance control for receiving and transmitting instructions and information to and from the control. A bezel made of non-electrically conductive material is mounted on a surface of the housing. An antenna is operatively coupled to the transceiver and is disposed within the bezel. In one embodiment, the radio frequency transceiver is disposed between the bezel and the housing. The bezel is formed of plastic.

### CROSS-REFERENCE TO RELATED APPLICATIONS

This. application claims priority to U.S. Provisional Application Ser. No. 60/719,089, entitled METHOD FOR CONVERTING AN APPLIANCE FOR USE WITH A WIRELESS COMMUNICATION DEVICE, filed Sep. 21, 2005, which is hereby expressly incorporated herein in its entirety by this reference.

### BACKGROUND OF THE INVENTION

This invention is directed to a structure for allowing wireless communication with an appliance, and more particularly an antenna structure for allowing wireless communication with an appliance.

Typically, commercial appliances such as ovens, fryers, refrigerators, washing machines or the like are constructed of stainless steel or other electrically conducting material. It is known in the art to control these devices remotely with the use of radio frequency or other electronic signals utilizing an antenna at the appliance. However, these devices, although satisfactory, have suffered from the shortcomings that because of the conductive shielding nature of the metallic housing of the appliance, the antenna cannot be placed within the appliance. Therefore, the typical approach is to include a radio transceiver inside the appliance and locate the antenna outside the appliance. However, this adds to the cost of the appliance because of the need for radio frequency connectors, the cost of external antenna and mounting hardware, the cost of the radio frequency cable to couple the circuitry and the problems associated with running the fragile cable from the appliance controller through the appliance to the antenna. Furthermore, the antenna must extend in a direction away from the appliance to be clear of the appliance limiting the positioning of the appliance on shelves and other tight areas within a kitchen or commercial environment where real estate is at a premium. Accordingly, an antenna structure for use with metallic appliance, which overcomes the shortcomings of the prior art is desired.

### BRIEF SUMMARY OF THE INVENTION

An appliance has a metallic housing. A radio frequency transceiver is mounted on the surface of the housing. The radio frequency transceiver is operatively coupled to an appliance control for receiving and transmitting instructions and information to and from the control. A bezel made of non-electrically conductive material is mounted on a surface of the housing. An antenna is operatively coupled to the transceiver and is disposed within the bezel.

In one embodiment, the radio frequency transceiver is disposed between the bezel and the housing. The bezel is formed of plastic.

### BRIEF DESCRIPTION OF THE DRAWINGS

For a fuller understanding of the invention, reference is had to the following description taken in connection with the accompanying drawing:

FIG. 1 in which a perspective exploded view of an appliance constructed in accordance with the invention is provided.

### DETAILED DESCRIPTION OF THE INVENTION

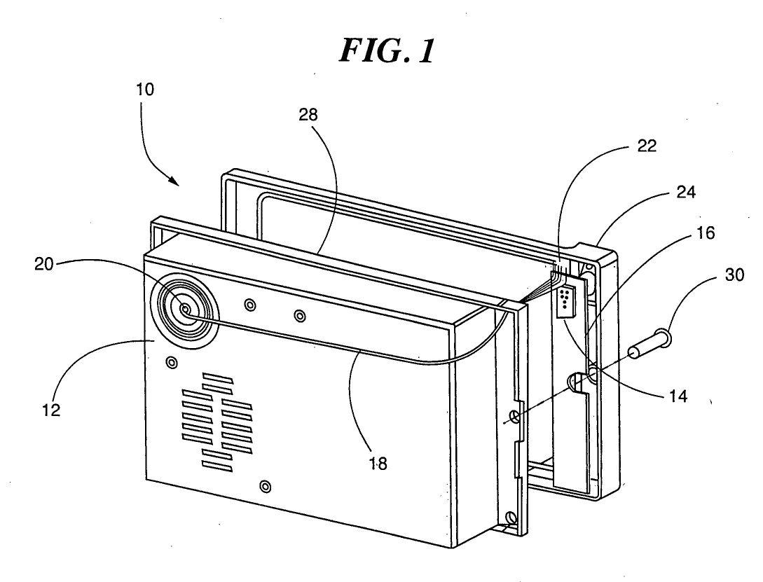

Reference is made to FIG. 1 in which an appliance, generally indicated as 10 constructed in accordance with the invention is provided. Appliance 10 includes a controller for controlling appliance 10 as known in the art. The controller is contained in a housing 12. Housing 12 is formed substantially of an electrically conductive material such as iron, stainless steel, other metals or the like, which is conductive to radio frequency signals.

Appliance 10 may be an oven, a washer, a refrigerator or the like appliance. For ease of description, appliance 10 may be referred to from time to time as an oven in an exemplary embodiment.

As is known in the art, appliance 10 is operated under the control of an onboard computer (controller), which either reports data to, or receives instructions from, a remote second control (not shown). The second control may either be a second appliance, a base station computer in wireless communication with appliance 10, a mobile device such as a cell phone or personal digital assistant or other handheld devices as known in the art.

The appliance onboard control communicates with the outside world with a remote controller by being communicatively coupled with a wireless transceiver 14 disposed on a wireless PC Board 16. As is shown, in a preferred embodiment, transceiver 14 is coupled to the controller through wires 18. Wires 18 extend from wireless PC Board 16 to an input 20 on controller housing 12. Transceiver 14 is coupled to an antenna 22, which transmits and receives the wireless signals from the remote controller. In a preferred embodiment, antenna 22 is a printed circuit antenna formed on PC Board 16. In this way, no expensive connectors are needed.

A bezel 24 formed of a non-electrically conductive material is mounted on controller housing 12. Bezel 24 may be made of plastic, rubber or the like. In a preferred embodiment, wireless PC Board 16 is disposed either within bezel 24 or between bezel 24 and housing 12 of the controller.

Because bezel 24 is formed on the appliance of a non-conductive material, antenna 22 is maintained on the outer surface of the appliance in a protected manner without interference of transmission of the radio frequency signals. Furthermore, as a bezel, having an opening 26 therein, bezel 24 does not interfere with the normal operation of the controller which on its front surface 28 may have either an LED display, LCD touch screen, touchpad, combination thereof or the like as known in the art.

It should be known that housing 12 may be formed of non-metallic or non-conductive materials, particularly if the appliance is formed of a metal. However, the benefit of the invention is best provided where housing 12 is formed of a radio frequency conductive material while bezel 22 is formed of a non-conductive material: Furthermore, the term radio frequency is utilized generically both to refer to the preferred embodiment of the use of radio frequency signals, but also to other wireless communication such as cellular, ultra high frequency or ultra low band frequencies may be utilized. Bosses may be disposed within the inner surface of the bezel around the fasteners and control area provided by opening 26 for compression of fastener 30 and a tighter seal for the front of controller 12 to minimize any dirt or grease migration within the bezel.

By providing non-conductive support structure associated with the appliance, the cost and real estate issues of the prior art are overcome while providing protection for the antenna itself. In a preferred embodiment, the antenna is printed onto the circuit board and the control signals are low frequency and therefore are amenable to use with inexpensive connectors and wires.

Thus, while there have been shown, described and pointed out novel features of the present invention as applied to preferred embodiments thereof, it will be understood that various omissions and substitutions and changes in the form and detail are contemplated so that the disclosed invention may be made by those skilled in the art without departing from the spirit and scope of the invention. It is the intention, therefore, to be limited only as indicated by the scope of the claims appended hereto. It is also to be understood that the following claims are intended to cover all of the generic and specific features of the invention herein described and all statements of the scope of the invention, which, as a matter of language might be said to fall therebetween.

What is claimed as new and desired to be protected by Letters Patent of the United States is:

1. An appliance comprising:
a housing at least partially formed of a radio frequency conductive material;
a controller disposed within the housing;
a transceiver for two-way communication between said controller and a remote controller by radio frequency;
an antenna communicatively coupled to said transceiver for transmitting and receiving said radio frequency signals between said remote controller and said controller; and
a bezel made of a non-radio frequency conductive material, said bezel being mounted on said housing, said antenna being mounted within said bezel.

2. A controller mounted within a housing comprising:
a housing at least partially formed of radio frequency conductive material;
a transceiver for two-way communication between said controller and a remote controller by radio frequency;
an antenna communicatively coupled to said transceiver for transmitting and receiving said radio frequencies corresponding to radio frequency signals between said remote controller and first controller; and
a bezel made of a non-radio frequency material, said bezel being mounted on said housing, said antenna being mounted within said bezel.

3. A bezel adapted to be mounted on an appliance, the bezel adapted to support an antenna therein, the bezel being formed of a non-radiofrequency conductive material; the antenna being in communication with a controller for controlling the appliance and receiving and transmitting data and instructions to and from a remote controller.
